(19) United States
(12) Patent Application Publication
(10) Pub. No.: US 2024/0278660 A1
(43) Pub. Date: Aug. 22, 2024

(54) MOTOR VEHICLE AND CHARGING DEVICE FOR A MOTOR VEHICLE FOR ELECTRICALLY CHARGING AN ENERGY STORAGE OF THE MOTOR VEHICLE

(71) Applicant: AUDI AG, Ingolstadt (DE)

(72) Inventor: Matthias HARDT, Neubiberg (DE)

(73) Assignee: AUDI AG, Ingolstadt (DE)

(21) Appl. No.: 18/405,397

(22) Filed: Jan. 5, 2024

(30) Foreign Application Priority Data
Feb. 17, 2023 (DE) 102023104046.4

(51) Int. Cl. B60L 53/16; H01R 13/52

(52) U.S. Cl. CPC B60L 53/16; H01R 13/521

(57) ABSTRACT

A charging device for a motor vehicle for electrically charging an energy storage of the motor vehicle. The charging device has a DC charging unit for conductive coupling to a DC charging plug, which includes a first and second connection pin and a first and second housing part with a respective housing wall which surrounds the respective connection pin and has a distance from the respective connection pin in the radial direction, whereby a respective insertion opening is provided between the connection pin and the housing part for inserting a respective contact element of the DC charging plug.

### FIELD

The invention relates to a charging device for a motor vehicle for electrically charging an energy storage of the motor vehicle, wherein the charging device has a DC charging unit for conductive coupling to a DC charging plug, wherein the DC charging unit comprises a first connection pin and a second connection pin. The charging device further comprises a first housing part with a first housing wall, which surrounds the first connection pin in the radial direction relative to the first connection pin and has a first distance from the first connection pin in this radial direction, whereby a first insertion opening between the first connection pin and the first housing part is provided for inserting a first contact element of the DC charging plug. The charging device further comprises a second housing part with a second housing wall, which surrounds the second connection pin in the radial direction relative to the second connection pin and has a second distance from the second connection pin in this radial direction, whereby a second insertion opening between the second connection pin and the second housing part is provided for inserting a second contact element of the DC charging plug. Furthermore, the invention also relates to a motor vehicle having such a charging device.

### BACKGROUND

Such a charging device can, for example, represent a charging socket that is located on the motor vehicle and into which a corresponding charging plug can be inserted for charging an energy storage of the motor vehicle. Today's charging sockets can have different designs. In addition to the connection pins for DC charging comprised in the charging device, such a charging device can, for example, also have additional connection elements for AC charging. When not in use, such a charging device is typically arranged behind a loading flap, which protects the charging device accordingly. The charging flap can, for example, be unlocked and opened or closed manually or automatically. If, for example, only the AC connections are used for AC charging during a charging process, the DC charging unit with its two connection pins is also exposed during such an AC charging process, since in this state the charging flap is open and the charging plug used for charging does usually not contact or cover the connection pins of the DC charging unit, which can also be referred to as DC pins.

In order to prevent dust or dirt from getting into the insertion openings of the DC charging unit in such a situation, an extra cover or something similar could be provided for the DC charging unit. The problem here again arises that this additional flap either has to be opened manually by a user in order to be able to use the DC charging unit, or this in turn has to be designed in a very expensive and complex manner in order to enable automatic opening, for example. However, especially in view of the development of automatic charging and plugging systems for automatically plugging the charging plug into a motor vehicle charging device, protective devices that have to be operated manually in order to remove or open them prove to be particularly disadvantageous.

Therefore, a protective device for the DC charging contacts, namely the connection pins, would be very advantageous, which device is neither has to be operated manually nor is particularly expensive or complex.

DE 10 2019 125 784 A1 describes a charging socket for a power supply arrangement for supplying a motor vehicle with electrical energy via a conductive plug connection with at least one electrical counter-contact for conductive contacting of a contact of a charging station. The electrical counter-contact is mounted displaceably in the radial direction between a first counter-contact position and a second counter-contact position with respect to a longitudinal central axis of the charging socket, wherein the charging socket has an adjusting ring which is rotatably mounted about the longitudinal central axis and which has at least one adjusting ramp which in a first angular position of the adjusting ring allows a displacement of the electrical counter-contact into the first counter-contact position and in a second angular position of the adjusting ring forces the electrical counter-contact into the second counter-contact position. It can also be provided that the protective ring runs over the electrical contact when it is moved between the first and second position, so that the protective ring causes the electrical contact to be cleaned. For this purpose, the protective ring can have a cleaning device facing the mechanical contact, such as a cleaning brush.

Here too, however, the charging socket and, above all, the design of the adjusting ring are extremely complex.

DE 20 2014 100 883 U1 describes a cover for a device installation box that is embedded in a wall and in which an electrical device is arranged, wherein the cover fits onto the device installation box. The cover has a glass plate, the outer dimensions of which in plan view are larger than the outer dimensions of the device installation box, and a plastic plate which in the plan view is at most the same size as the glass plate and on which the glass plate is applied and with which the glass plate can be mounted on the device installation box or the electrical device. Depending on the application, the cover can be designed differently. The cover can have an opening through which connections behind it are accessible, such as a Schuko socket. To cover the connections when not in use, a brush seal can be present, which is held with a ring on the edge of the opening between the glass plate and the plastic plate.

### SUMMARY

The object of the present invention is to provide a charging device for a motor vehicle and a motor vehicle which, when the charging flap is open, enables an additional protection option for a DC charging unit in an unused state, wherein the protection option is designed to be as simple, space-efficient and cost-effective as possible and in particular does not have to be operated manually for use of the DC charging unit.

A charging device according to the invention for a motor vehicle for electrically charging an energy storage of the motor vehicle has a DC charging unit for conductive coupling with a DC charging plug, wherein the DC charging unit comprises a first connection pin and a second connection pin, and a first housing part with a first housing wall which surrounds the first connection pin in a radial direction relative to the first connection pin, and in this radial direction has a first distance from the first connection pin, whereby a first insertion opening is provided between the first connection pin and the first housing part for inserting a first contact element of the DC charging plug. The charging device further comprises a second housing part with a second housing wall, which surrounds the second connection pin in the radial direction relative to the second connection pin and has a second distance from the second connection pin in this radial direction, whereby a second insertion opening between the second connection pin and the second housing part is provided for inserting a second contact element of the DC charging plug. The charging device has a first dust protection device, which comprises a frame and a plurality of flexible bristles, each of which has a first end and an opposite second end, wherein the bristles are circumferentially attached to the frame with their respective first end so that their respective second ends protrude inwards relative to the frame and point towards each other, wherein the first dust protection device is arranged on the first housing part in such a way that part of the first insertion opening is covered by the bristles.

The first dust protection device can therefore provide a type of eyelash ring or bristle ring, the flexible bristles of which protrude inwards, in particular in the direction of a central axis of the first insertion opening, along which the first connection pin is arranged. Due to the flexible design of the bristles, it is advantageously possible to automatically push them aside by the insertion process when the first contact element is inserted into the first insertion opening and, so to speak, to push them against the first housing wall. The bristles advantageously provide dust protection when the DC charging unit is not in use, and at the same time they do not hinder the insertion process for inserting the first contact element into the first insertion opening. The first dust protection device therefore advantageously does not require any manual operation or removal in order to be able to use the DC charging unit. At the same time, no complex mechanics or any adjusting mechanism or anything similar is required. The dust protection device can therefore be provided in a simple manner by an eyelash ring or a bristle ring, which is arranged at a corresponding location, in particular on the first housing part, in order to advantageously provide dust protection.

The dust protection device described is therefore also ideal for implementing automated plugging processes for connecting a charging plug to the motor vehicle charging device, for example by means of a robot. In addition, the dust protection device described can be used advantageously or contribute to, for example, providing protection in accordance with IP44 for the DC charging unit when unused. For this purpose, the charging device can additionally have a drain for liquids, for example for splash water, in the area of the DC charging unit, for example within the first and/or second housing part. This means that, in combination with the dust protection device, dust and splash water protection in accordance with IP44 can advantageously be provided, which does not hinder the insertion process of a DC charging plug into the DC charging unit and does not have to be operated manually.

It should also be noted that there is no safety risk in the event that dust or dirt gets into a corresponding insertion opening or, in particular, into contact with the connection pins. This can only reduce the efficiency of the charging process, as filth or dirt, especially on the connection pins, increases the contact resistance, which leads to increased power loss, which reduces the charging efficiency and also leads to greater heating of the connection pins themselves. The charging device also preferably has a temperature sensor, by means of which a temperature above a threshold value can be determined and a charging process can then be interrupted, for example. This also reduces the charging efficiency. Thanks to the dust protection device, it is now advantageously possible to prevent dust or dirt from getting into the region of the insertion openings. This can increase the charging efficiency or prevent a reduction in charging efficiency.

The charging device for the motor vehicle can in particular be designed as a charging socket. Moreover, in addition to the DC charging unit, the charging device can also include, for example, an AC charging unit, in particular with corresponding AC connections or contact pins, as will be explained in more detail later. The first housing part, in which the first connection pin is arranged in a recessed manner, and the second housing part, in which the second connection pin is arranged in a recessed manner, do not necessarily have to be separate housing parts, but can also be two parts of a common, integrally designed housing. In other words, the first housing part and the second housing part can be formed in one integral piece. The charging device can also comprise further housing parts, which can also be formed in one piece and integrally with the first and/or second housing part. The housing parts can, for example, be made of an electrically non-conductive material, for example a plastic material.

The first and second connection pins are preferably formed partly or completely from a metallic material. If necessary, the front ends of these connection pins can be designed with an electrically insulating protective cap or something similar. The corresponding contact elements of the DC charging plug can be, for example, contact sleeves into which the respective connection pins can be inserted. The sleeves can be inserted accordingly into the respective insertion openings, which are provided by the distance between the housing part and the connection pin. These sleeves can, for example, also be formed from an electrically conductive material, in particular metallic material, or at least comprise contact surfaces made from such an electrically conductive material, which, when inserted, contact the corresponding electrically conductive contact surfaces of the relevant connection pins.

Furthermore, the two connection pins are preferably aligned parallel to one another. In addition, the connection pins can be arranged in their respective housing parts in such a way that they are slightly set back in relation to the end faces of the respective housing parts, which preferably lie in a common plane. The first connection pin can, for example, be associated with a first potential connection and the second connection pin with a second potential connection. The two potentials relate to the potentials of an energy storage of the motor vehicle that is to be charged by means of the charging device, which storage can be designed, for example, as a high-voltage battery.

According to a further advantageous embodiment of the invention, the charging device has a second dust protection device, which is designed like the first dust protection device and which is arranged on the second housing part in such a way that part of the second insertion opening is covered by the bristles of the second dust protection device. In other words, the second insertion opening can also be made dust-protected by means of such a second dust protection device, which can be designed in the same way as already described for the first dust protection device. Incidentally, the following descriptions, which relate to the first dust protection device, can also apply in a completely analogous manner to the second dust protection device with regard to the second connection pin, the second housing part and the second insertion opening. These exemplary embodiments will therefore not be explained again separately for the second dust protection device.

It is therefore advantageous if the second dust protection device also comprises a frame, namely a closed surrounding border of a through opening, and a plurality of flexible bristles, each of which has a first end and an opposite second end, wherein the bristles of the second dust protection device are arranged with their respective first end around and on the frame of the second dust protection device and are fastened to the frame, so that their respective second ends protrude inwards and point towards one another, wherein the second dust protection device is arranged on the second housing part in such a way that the bristles of the second dust protection device correspondingly cover a part of the second insertion opening.

Furthermore, the first and second insertion openings can each be only partially or essentially completely covered by the corresponding bristles. This can be achieved, for example, simply by attaching a sufficient number of bristles sufficiently close to the frame.

Furthermore, it is preferred that the bristle density is at least approximately constant in the circumferential direction. If, for example, all bristles are of the same length, this results in an ever-increasing bristle density as the distance to a central axis becomes increasingly smaller. It would also be conceivable that the bristles are of different lengths. In addition to long bristles, which are arranged circumferentially surrounding on the frame and projecting inwards, second, shorter bristles can also be arranged circumferentially on the frame and, for example, be at least partially offset in the circumferential direction from the long bristles and arranged projecting inwards on the frame. This allows the bristle density in the edge region of the frame to be increased and any possible gaps may be closed without the bristles overlapping too much in the central region of the frame.

In a further advantageous embodiment of the invention, the first housing wall has a cylindrical geometry, wherein the first connection pin is arranged along a central axis of the cylindrical first housing wall. The same can apply to the second housing wall and the second connection pin. In the first housing part, for example, there can be a cylindrical recess in which the first connection pin is centrally arranged. The distance between the first housing wall and the first connection pin can therefore be constant or at least substantially constant. As explained in more detail later, it is, for example, very advantageous, in order to attach the eyelash ring to the first housing wall, to provide a groove in the first housing wall, into which groove the eyelash ring can be inserted. Apart from such a groove, the first housing wall can have a constant distance from the central connection pin.

This also makes it easier to design the first dust protection device and in particular its frame. In principle, it is conceivable that this recess in the first housing part, in which the first connection pin is arranged, can have any geometry, for example it could also be cuboid. However, a cylindrical design has become established in this case. In principle, the frame of the dust protection device, which is preferably arranged on the housing wall and thus in such a recess, could have any geometry adapted to the insertion opening, and could also be rectangular, for example.

Especially with the cylindrical design of the housing wall described above, it is correspondingly preferred that the frame of the first dust protection device is also annular and is arranged in particular on the first housing wall, in particular at a third distance from an end face of the first housing part. In principle, it would also be conceivable for the frame not to be arranged on the first housing wall and accordingly not within the insertion opening, but instead to be arranged on the end face of the first housing part when viewed from the insertion direction, and thus still arranged in front of the front end of the first connection pin, when viewed in the axial direction or the insertion direction. In this case, it would be preferred for the bristles to project radially inward in such a way that their respective second ends touch each other or the bristles cross each other. This ensures that no gap remains in the central region, namely in the middle of the frame. The bristles can also be arranged partially offset from one another and then overlap slightly.

However, the design of the first dust protection device is significantly simpler if it is not arranged on the front side of the first housing part, but is located within the insertion opening, that is, arranged on the first housing wall. The external geometry of the frame can therefore correspond to the internal geometry of the housing wall. With a cylindrical design of the housing wall, a correspondingly annular design of the frame of the dust protection device is very advantageous. Furthermore, the frame can be designed to be rigid or, preferably, somewhat flexible or even elastic, for example as an O-ring or similar to an O-ring. This makes it easier to attach the frame in the housing wall. In addition, the frame can, for example, be glued on the inside to the first housing wall or simply be plugged in. In the second case, the frame is particularly easy to remove from the insertion opening and from the housing wall. This makes maintenance of the dust protection device easier. In particular, this device can easily be replaced with a new dust protection device if it is defective or already worn out.

In a further particularly advantageous embodiment of the invention, a circumferential groove is arranged in the first housing wall, in which the frame of the first dust protection device is at least partially arranged. This groove can also be designed in a ring shape. The plane in which this groove runs is preferably aligned perpendicular to the first connection pin or to its longitudinal extension direction, which corresponds to the plugging direction. This groove allows the frame to be particularly easily attached to the first housing wall. Another particularly important advantage of such a circumferential groove is that the frame itself does not protrude into the insertion opening, or only slightly and at least not significantly, so that the insertion process is not hindered or impaired. The frame can, for example, be flush with the rest of the housing wall with only the bristles protruding radially inwards towards the first connection pin. The frame can also protrude slightly beyond the first housing wall. However, thanks to the groove, this projection can be made particularly small.

In a further very advantageous embodiment of the invention, the frame of the first dust protection device is positioned on the first housing wall in such a way that the frame and/or the second ends of the bristles lie in the axial direction with respect to the first connection pin in the same plane as a front end of the first connection pins or are set back by a fourth distance from the front end of the first connection pin. Therefore, when observing the charging device from the insertion direction, the first connection pin is preferably not covered by the bristles of the first dust protection device. The front end of the first connection pin is thus still visible. This has several major advantages: On the one hand, it simplifies the arrangement and design of the bristles and their distribution around the frame, as already described above, since they then do not necessarily have to overlap or touch each other in the central region, since the central hole, so to speak, which remains between the second ends of the bristles, is closed by the connecting pin itself. Another big advantage is that this configuration is very advantageous if the plugging process for plugging in a charging plug, such as the DC charging plug, is to be carried out by a robot. In particular, it can be provided that such a charging robot uses a camera to insert the charging plug into the charging device. In other words, the charging robot recognizes the charging device as well as the corresponding pins and connections to which the corresponding charging plug is to be coupled based on the camera images recorded by the camera. For this purpose, for example, the front ends of the first and second connection pins can serve as an identification feature for the robot. The robot can orient itself with respect to these front ends of these connection pins. Covering these connection pins accordingly requires changing and modifying the detection software for detecting the charging device based on significant features extracted from the captured camera images. If the dust protection device is now designed in such a way that the front ends of the connection pins are not covered, existing detection algorithms can still be used and reliable detection of the charging device can be ensured.

In principle, the frame or the second end of the bristles can be set back as desired in the axial direction relative to the front end of the first connection pin. However, the further back the bristles are set, the less dust protection they provide. It is therefore preferred that the fourth distance by which the frame or the second ends of the bristles are set back is a maximum of 1 mm or a maximum of 0.5 mm. The frame or the second end of the bristles can therefore only be set back slightly in the axial direction relative to the front end of the first connection pin. This still ensures very efficient dust protection.

According to a further advantageous embodiment of the invention, the bristles protrude with their second ends in the direction of the first connection pin and in particular they touch the first connection pin. This means that the first insertion opening can be covered particularly efficiently by the bristles.

In general, the bristles are preferably designed to be relatively thin in terms of their diameter, which can be, for example, in the range of 1 mm or 1.5 mm. However, the bristles can also be made thinner. The bristles are preferably made of plastic material. These are particularly preferably made of polytetrafluoroethylene (PTFE). But other plastics materials are also suitable. A plastic material with a melting point above 100 degrees Celsius is preferably used. This means that the bristles are sufficiently heat-resistant to withstand the typical temperatures in the region of the connection pins, especially during a charging process. The temperatures in the region of the connection pins can be up to 70 degrees Celsius, while the temperatures further away from these pins, for example in the region of the housing walls, are significantly lower.

In a further advantageous embodiment of the invention, the bristles protrude inwards from the frame of the first dust protection device in such a way that the bristles and the frame of the first dust protection device lie in one plane, or the bristles are inclined at an angle relative to the frame plane defined by the frame in the insertion direction, in which the first contact element can be inserted into the first insertion opening. The formation of the bristles in one plane with the frame enables a particularly simple design. In addition, the bristles can be made particularly short. The inclination at an angle relative to the frame plane, in particular in the insertion direction, has the advantage that the inclination of the bristles can already provide a preferred direction with regard to the pushing away and bending of the bristles by inserting the first contact element. The angle of inclination is dimensioned such that there is, so to speak, an equal angle between each bristle and the central connection pin, which preferably deviates only slightly from a right angle. The bristles are then all inclined towards the central connection pin. On the other hand, if the bristles lie in one plane together with the frame, there is essentially a right angle between each bristle and the central connection pin.

In a further advantageous embodiment of the invention, the charging device has AC connections for AC charging, in particular, wherein the charging device is designed as a CCS (Combined Charging System) charging socket. In particular, the charging device can be designed as a CCS2 charging socket or as a so-called Combo 2 charging socket or also as a CCS1 charging socket, that is, as a Combo 1 charging socket.

In any case, it is advantageous if the charging device additionally has AC connections for AC charging, which are different from the DC connections described, namely the two DC connection pins. In this case in particular, it can happen that the AC connections are occupied by the corresponding charging plug for AC charging, but the DC connection pins are not covered by this plugged-in charging plug. It is precisely then that the dust protection device provided is very advantageous, since it still provides dust protection for the corresponding DC connection pins when the charging device is used to charge the energy storage, and therefore a protective cap or charging flap that covers the charging device when not in use is not closed.

In principle, the dust protection device also offers protection if no additional AC charging unit is part of the charging device. Even then, the dust protection device can be used advantageously to protect the DC pins or to protect the insertion openings in the meantime between opening of the charging flap and insertion of the DC charging plug.

Furthermore, the invention also relates to a motor vehicle having a charging device according to the invention or one of its embodiments. The advantages mentioned for the charging device according to the invention and its designs thus apply equally to the motor vehicle according to the invention.

The motor vehicle can, for example, also have the loading flap described, which can close the charging device from the outside and which can be opened, for example manually and/or automatically, and which can also be locked in the closed state. In addition, the motor vehicle can comprise the energy storage, which can be electrically charged using the charging device.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that each have a combination of the features of several of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a charging device for a motor vehicle according to an exemplary embodiment of the invention;

FIG. 2 shows a schematic representation of a dust protection device for a charging device according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

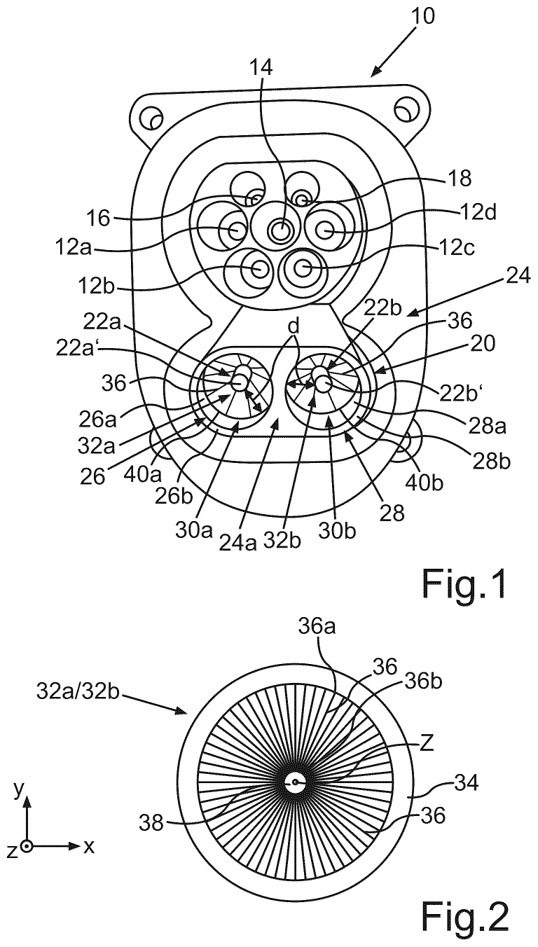

FIG. 1 shows a schematic illustration of a charging device 10 according to an exemplary embodiment of the invention. In this example, the charging device 10 is designed as a CCS2 charging socket 10. The charging device 10 comprises four AC connections 12a, 12b, 12c, 12d, including a connection 12a for a neutral conductor and three connections 12b, 12c, 12d as phase connections. This enables charging with three-phase alternating current. In addition, the charging socket 10 includes a connection 14 to a protective conductor, which is also referred to as PE (Protective Earth), as well as a connection 16, which is also usually referred to as CP (Control Pilot), for dialogue between the charging station and the vehicle, and another Connection 18, which is also referred to as PP (Proximity Pilot) for limiting the charging current using resistance coding. In addition, the charging device 10 includes a DC charging unit 20 for DC charging, namely electrical charging of the energy storage of the motor vehicle with direct current. The DC charging unit 20 comprises two connections, namely a first connection pin 22a and a second connection pin 22b.

In addition, the charging device 10 comprises a housing 24, which can basically be divided into several housing parts, which, however, are formed in one piece in the present example. A part or region of this housing 24 is associated with the DC charging unit 20 and is designated 24a in the present case. This DC charging unit housing 24a can in turn be divided into two housing parts 26, 28, wherein a first housing part 26 is associated with the first connection pin 22a, and the second housing part 28 is associated with the second connection pin 22b. Each of these two housing parts 26, 28 has a cylindrical housing wall 26a, 28a, in the center of which the respective connection pin 22a, 22b is located, and extends along the imaginary cylinder axis of the associated housing wall 26a, 26b. The housing wall 26a, 28a thus surrounds the associated connection pin 22a, 22b in the radial direction and is at a certain distance d from it, which is in particular essentially constant. In addition, each housing part 26, 28 has an end face 26b, 28b. The front ends 22a ‘, 22b’ of the respective pins 22a, 22a can be slightly set back relative to the respective end faces 26b, 28b of the housing parts 26, 28, in particular with respect to an axial direction, which is defined by the longitudinal extension direction, along which the connection pins 22a, 22b extend.

Due to the distance d between the respective housing wall 26a, 28a and the corresponding pins 22a, 22b, a respective insertion region or insertion opening 30a, 30b is provided between the pin 22a, 22b and the associated housing wall 26a, 28a, in which a corresponding contact element of a DC charging plug can be inserted, which is particularly sleeve-shaped.

Such a charging socket 10, when installed as intended on an electric vehicle, is usually protected by a charging flap to protect it from water and dust as long as no plug is plugged in and no charging process is active. For example, if an AC charging process is to be carried out and a corresponding AC charging plug is plugged into the charging device 10, the corresponding AC connections 12a, 12b, 12c, 12d as well as the remaining three connections 14, 16, 18 are occupied in the upper region of the charging socket 10, while the DC charging unit 20 is not covered by this charging plug. In order to achieve a degree of protection IP44 for the DC charging unit 20 in such a situation, on the one hand at least one drain is provided in the housing 24, through which penetrating water, for example splash water or rainwater or the like, can drain away. In addition, this charging device 10 now advantageously has an associated dust protection device 32a, 32b for a respective connection pin 22a, 22b, which device in this example is designed as an eyelash ring 32a, 32b.

Such a dust protection device 32a, 32b is shown again schematically in a top view in FIG. 2. Such a dust protection unit 32a, 32b designed as an eyelash ring 32a, 32b comprises a frame 34, in particular an annular frame 34, and a plurality of bristles 36 or eyelashes 36, each of which has a first end 36a and an opposite second end 36b, wherein for reasons of clarity these ends 36a, 36b in FIG. 2 are provided with a reference number only for an eyelash or bristle 36. Also only two exemplary bristles 36 are provided with a reference numeral for reasons of clarity. The bristles 36 are attached to the frame 34 with their respective first end 36a and are arranged as evenly distributed as possible around the frame, so that their respective second ends 36b protrude radially inwards and face each other, in particular in the direction of an imaginary center Z, which can represent the center of the annular frame 34 or an axis through the center that is perpendicular to the frame plane, which is defined by the frame 34 and is parallel to the x-y plane of the coordinate system shown. If this eyelash ring 32a, 32b is arranged as intended on the charging device 10, as shown in FIG. 1, the z direction shown in FIG. 2 is directed parallel and against the intended insertion direction, in which a corresponding contact element of a DC plug is inserted into the DC charging unit 20.

The bristles 36 can also be aligned in such a way that they also lie in the frame plane of the frame 34 or are inclined at an angle relative to this plane. In this case, the bristles 36 are then inclined so that their second ends 36b are at a greater distance from the end faces 26b, 28b of the housing parts 26, 28 than the first ends 36a.

In principle, it is possible to also attach the frame 34 to the front face of the housing parts 26, 28 in order to at least partially cover the respective insertion openings 30a, 30b with the bristles 36. However, it is preferred that these dust protection devices 32a, 32b are arranged within the respective insertion openings 30a, 30b, as shown in FIG. 1. The frame 34 is arranged on the respective housing wall 26a, 28a. It is particularly advantageous if the respective housing wall 26a, 28a is provided with an annular surrounding groove in which the frame 34 can be arranged recessed at least partially in the radial direction with respect to the respective pin 22a, 22b. As a result, essentially only the bristles 36 protrude radially into the respective insertion opening 30a, 30b. In addition, the bristles are flexible and can bend backwards when a DC charging plug is inserted into the respective insertion openings 30a, 30b, that is, against the z-direction shown in relation to FIG. 2, and can be pressed against the respective housing wall 26a, 28a. The eyelash ring 32a, 32b is therefore fastened in the housing 24 of the charging socket 10 in such a way that it does not make it difficult to insert the charging plug and the charging plug presses the eyelashes, that is to say the bristles 36, against the respective housing wall 26a, 28a. If the eyelash ring 32a, 32b is also arranged so deeply recessed in the respective insertion opening 30a, 30b that at least the second ends 36b of the bristles 36 are slightly further back than the front ends 22a ‘, 22b’ of the pins 22a, 22b, then the bristles 36 can be designed as illustrated in FIG. 2 and do not necessarily have to protrude into the center Z. In other words, the bristles 36 can be dimensioned and arranged in such a way that a small hole 38 remains in the middle of the eyelash ring 32a, 32b, which, when properly arranged, is filled or closed by the corresponding pin 22a, 22b. It is also preferred that the respective pin 22a, 22b only protrudes slightly from the eyelash ring 32a, 32b in the z direction. This allows the protective effect to be maximized. This eyelash ring 32a, 32b now advantageously protects the respective insertion opening 30a, 30b from the ingress of dust or contaminants. The eyelash ring 32a, 32b can also be attached to the charging socket 10 using an adhesive or the like or simply inserted, for example into the mentioned groove 40a, 40b. This has the advantage that the eyelash ring 32a, 32b can be easily replaced.

A groove 40a, 40b is preferably introduced into the housing 24 of the charging socket 10 in the front region of the DC pin frame, namely in the respective housing walls 26a, 28a, in which the eyelash ring 32a, 32b is embedded and fixed. The eyelash ring 32a, 32b itself is preferably made of elastic material so that the inserted charging plug can push the eyelashes 36 away. The ring material, that is to say the material of the frame 34, is preferably elastic, for example made of a plastic material, so that the ring 32a, 32b can be easily removed from the groove 40a, 40b and replaced in the event of damage. The ring 32a, 32b, in particular the annular frame 34, can also be fixed in the groove 40a, 40b, for example, with a suitable adhesive.

Overall, the examples show how the invention can be used to provide an eyelash ring as a dust protection in the charging socket of electric vehicles. This makes it possible to provide adequate dust protection for the DC pins, so that, for example, a manually operated flap to protect the pins can be eliminated. For example, water can be drained away through a converted drain. Dust protection can thus be achieved using an eyelash ring that prevents dirt particles from penetrating. This also enables automated DC charging via the CCS charging socket in a cost-effective manner without manual intervention.

1. A charging device for a motor vehicle for electrically charging an energy storage of the motor vehicle, wherein the charging device comprises:
a DC charging unit for conductive coupling with a DC charging plug, wherein the DC charging unit comprises a first connection pin and a second connection pin, a first housing part with a first housing wall, which surrounds the first connection pin in a radial direction relative to the first connection pin and has a first distance from the first connection pin in said radial direction, thereby providing a first insertion opening between the first connection pin and the first housing part for inserting a first contact element of the DC charging plug; a second housing part with a second housing wall, which surrounds the second connection pin in a radial direction relative to the second connection pin and has a second distance from the second connection pin in said radial direction, thereby providing a second insertion opening between the second connection pin and the second housing part for inserting a second contact element of the DC charging plug;
wherein the charging device has a first dust protection device, which comprises a frame and a plurality of flexible bristles, each of which has a first end and an opposite second end, wherein the bristles are circumferentially attached to the frame with their respective first end so that their respective second ends protrude inwards relative to the frame and point towards each other, wherein the first dust protection device is arranged on the first housing part in such a way that part of the first insertion opening is covered by the bristles.

2. The charging device according to claim 1, wherein the charging device has a second dust protection device, which is configured like the first dust protection device and which is arranged on the second housing part in such a way that the bristles of the second dust protection device cover part of the second insertion opening.

3. The charging device according to claim 1, wherein the first housing wall has a cylindrical geometry, wherein the first connection pin is arranged along a central axis of the cylindrical first housing wall.

4. The charging device according to claim 1, wherein the frame of the first dust protection device is ring-shaped and is arranged in particular on the first housing wall, in particular at a third distance from an end face of the first housing part.

5. The charging device according to claim 1, wherein a circumferential groove is arranged in the first housing wall, in which the frame of the first dust protection device is at least partially arranged.

6. The charging device according to claim 1, wherein the frame of the first dust protection device is positioned on the first housing wall in such a way that the frame and/or the second ends of the bristles in the direction of the axial pin are arranged in the same plane as a front end of the first connection pin or are set back relative to the front end of the first connection pin by a fourth distance, in particular by a maximum of 1 mm or a maximum of 0.5 mm.

7. The charging device according to claim 1, wherein the bristles protrude with their second ends in the direction of the first connection pin, and in particular touch the first connection pin.

8. The charging device according to claim 1, wherein the bristles protrude from the frame of the first dust protection device in such a way that the bristles and the frame of the first dust protection device are arranged in one plane or the bristles are inclined at an angle relative to the frame plane defined by the frame in the insertion direction in which the first contact element can be inserted into the first insertion opening.

9. The charging device according to claim 1, wherein the charging device has AC connections for AC charging, in particular wherein the charging device is configured as a CCS (Combined Charging System) charging socket.

10. A motor vehicle having a charging device according to claim 1.

11. The charging device according to claim 2, wherein the first housing wall has a cylindrical geometry, wherein the first connection pin is arranged along a central axis of the cylindrical first housing wall.

12. The charging device according to claim 2, wherein the frame of the first dust protection device is ring-shaped and is arranged in particular on the first housing wall, in particular at a third distance from an end face of the first housing part.

13. The charging device according to claim 3, wherein the frame of the first dust protection device is ring-shaped and is arranged in particular on the first housing wall, in particular at a third distance from an end face of the first housing part.

14. The charging device according to claim 2, wherein a circumferential groove is arranged in the first housing wall, in which the frame of the first dust protection device is at least partially arranged.

15. The charging device according to claim 3, wherein a circumferential groove is arranged in the first housing wall, in which the frame of the first dust protection device is at least partially arranged.

16. The charging device according to claim 4, wherein a circumferential groove is arranged in the first housing wall, in which the frame of the first dust protection device is at least partially arranged.

17. The charging device according to claim 2, wherein the frame of the first dust protection device is positioned on the first housing wall in such a way that the frame and/or the second ends of the bristles in the direction of the axial pin are arranged in the same plane as a front end of the first connection pin or are set back relative to the front end of the first connection pin by a fourth distance, in particular by a maximum of 1 mm or a maximum of 0.5 mm.

18. The charging device according to claim 3, wherein the frame of the first dust protection device is positioned on the first housing wall in such a way that the frame and/or the second ends of the bristles in the direction of the axial pin are arranged in the same plane as a front end of the first connection pin or are set back relative to the front end of the first connection pin by a fourth distance, in particular by a maximum of 1 mm or a maximum of 0.5 mm.

19. The charging device according to claim 4, wherein the frame of the first dust protection device is positioned on the first housing wall in such a way that the frame and/or the second ends of the bristles in the direction of the axial pin are arranged in the same plane as a front end of the first connection pin or are set back relative to the front end of the first connection pin by a fourth distance, in particular by a maximum of 1 mm or a maximum of 0.5 mm.

20. The charging device according to claim 5, wherein the frame of the first dust protection device is positioned on the first housing wall in such a way that the frame and/or the second ends of the bristles in the direction of the axial pin are arranged in the same plane as a front end) of the first connection pin or are set back relative to the front end of the first connection pin by a fourth distance, in particular by a maximum of 1 mm or a maximum of 0.5 mm.
